(19) United States
(12) Patent Application Publication
(10) Pub. No.: US 2026/0018645 A1
(43) Pub. Date: Jan. 15, 2026

(54) CRIMPING APPARATUS AND METHOD FOR CYLINDRICAL SECONDARY CELLS

(71) Applicant: SK ON CO., LTD., Seoul (KR)

(72) Inventor: Moon Hyung JUNG, Daejeon (KR)

(21) Appl. No.: 19/262,096

(22) Filed: Jul. 8, 2025

(30) Foreign Application Priority Data
Jul. 15, 2024 (KR) 10-2024-0093193

(51) Int. Cl. H01M 10/04; H01M 50/107; H01M 50/167

(52) U.S. Cl. CPC H01M 10/0404; H01M 50/167; H01M 50/107

(57) ABSTRACT

A crimping apparatus according to an exemplary embodiment of the present disclosure includes: a roller support device disposed to be movable up and down in an axial direction of a battery case; and a roller connected to the roller support device and configured to press an opening part of the battery case, wherein the roller may be disposed to be movable in a radial direction of the battery case.

### CROSS-REFERENCE TO RELATED APPLICATION

This patent application claims the priority and benefits of Korean patent application No. 10-2024-0093193, filed on Jul. 15, 2024 the disclosure of which is incorporated herein by reference in its entirety.

### BACKGROUND OF THE INVENTION

### 1. Field of the Invention

The present disclosure relates to a crimping apparatus and method for cylindrical secondary cells.

### 2. Description of the Related Art

Secondary cells are used as energy sources in electric vehicles or electronic devices. In the secondary cell, a jelly-roll-type electrode assembly, in which an anode plate, a cathode plate, and separators are wound together, is used, or alternatively, an electrode assembly fabricated by stacking an anode plate, a cathode plate, and a separator in an appropriate order may be used.

In a cylindrical secondary cell that uses a jelly-roll type electrode assembly, the electrode assembly is accommodated inside a cylindrical battery case, and the anode and cathode are connected to an anode terminal and a cathode terminal, respectively.

In addition, the battery case is closed using a cover member while the inside is filled with an electrolyte, and then sealed through a crimping process.

### SUMMARY OF THE INVENTION

According to an aspect of the present disclosure, it is an object to provide a crimping apparatus and method capable of improving the efficiency of a crimping process of a cylindrical secondary cell.

A crimping apparatus according to exemplary embodiments of the present disclosure may include: a roller support device disposed to be movable up and down in an axial direction of a battery case; and a roller connected to the roller support device and configured to press an opening part of the battery case, wherein the roller may be disposed to be movable in a radial direction of the battery case.

In exemplary embodiments, the roller may include at least two or more inclined parts having different inclined structures, and may press the opening part by the two or more inclined parts.

In exemplary embodiments, the roller may include an outer inclined part and an inner inclined part extending radially inward from the outer inclined part, and wherein the roller may be configured to primarily press the opening part by one of the inner inclined part or the outer inclined part, and secondarily press the opening part by the other.

In exemplary embodiments, the roller may be characterized in that: a pressing surface of the outer inclined part that presses the opening part may be formed to be inclined at a first angle with respect to an imaginary line perpendicular to a central axis of the battery case when viewed from the side, and a pressing surface of the inner inclined part that presses the opening part may be formed to be inclined at a second angle with respect to the imaginary line perpendicular to the central axis of the battery case when viewed from the side.

In exemplary embodiments, the first angle may be formed to be greater than the second angle.

In exemplary embodiments, the roller may be configured to primarily press the opening part by the outer inclined part, and secondarily press the opening part by the inner inclined part.

In exemplary embodiments, the roller may be configured to, after primarily pressing the opening part, move radially outward, and in this state, secondarily press the opening part.

In exemplary embodiments, the primary pressing and the secondary pressing may be performed through downward movement of the roller.

In exemplary embodiments, the roller may include a buffer part formed between the outer inclined part and the inner inclined part to alleviate impact on the opening part.

In exemplary embodiments, the roller may include a guide part configured to guide alignment of at least one of the inner inclined part or the outer inclined part with the opening part.

In exemplary embodiments, the first angle may be formed to be smaller than the second angle.

In exemplary embodiments, the roller may be configured to primarily press the opening part by the inner inclined part and secondarily press the opening part by the outer inclined part.

In exemplary embodiments, the roller may be configured to secondarily press the opening part while moving radially inward after primarily pressing the opening part.

In exemplary embodiments, the roller may perform the primary pressing and the secondary pressing at the same height with respect to the opening part.

In exemplary embodiments, the roller may include a stopper part formed on an outer end of the outer inclined part to limit the radial movement of the roller.

In exemplary embodiments, the roller support device may be disposed to be rotatable about a central axis of the battery case, and the roller may slide along a periphery of the opening part according to the rotation of the roller support device to press the opening part.

In exemplary embodiments, the roller may be disposed to be rotatable about a rotational axis that is perpendicular to the axial direction.

In exemplary embodiments, the crimping apparatus may further include a roller driving device that is connected to the roller and coupled to the roller support device to allow the roller to move in a radial direction.

A method for crimping a cylindrical secondary cell according to exemplary embodiments of the present disclosure may include: initially aligning a crimping apparatus, which includes a roller, with respect to an opening part of a battery case; primarily lowering the roller to primarily press the opening part by an outer inclined part of the roller; moving the roller radially outward; and secondarily lowering the roller to secondarily press the opening part by an inner inclined part of the roller.

A method for crimping a cylindrical secondary cell according to exemplary embodiments of the present disclosure may include: initially aligning a crimping apparatus, which includes a roller, with respect to an opening part of a battery case; moving the roller radially inward to primarily press the opening part by an inner inclined part of the roller; continuously moving the roller radially inward to secondarily press the opening part by an outer inclined part of the roller.

The crimping apparatus according to an exemplary embodiment of the present disclosure may prevent deformation of the beading part and the case even when the crimping part is formed in a thick battery case by gradually bending the opening part of the battery case.

In the present disclosure, the gradual bending process of the opening part may be performed using a single roller, thereby reducing manufacturing costs and improving process efficiency.

### BRIEF DESCRIPTION OF THE DRAWINGS

The above and other objects, features and other advantages of the present disclosure will be more clearly understood from the following detailed description taken in conjunction with the accompanying drawings, in which:

FIG. 1 is a cross-sectional view schematically illustrating a secondary cell to which a crimping apparatus according to an exemplary embodiment of the present disclosure may be applied;

FIG. 2 is a view schematically illustrating the crimping apparatus according to an exemplary embodiment of the present disclosure;

FIG. 3 is a view illustrating an inclined structure of an inclined part according to an exemplary embodiment by enlarging portion A of FIG. 2;

FIGS. 4 and 5 are schematic views illustrating a procedure for performing a crimping process by a roller according to an exemplary embodiment of the present disclosure;

FIGS. 6 and 7 are enlarged schematic views illustrating a procedure for performing the crimping process by the roller according to an exemplary embodiment of the present disclosure;

FIG. 8 is a schematic view illustrating a crimping apparatus according to another exemplary embodiment of the present disclosure;

FIG. 9 is a view illustrating an inclined structure of an inclined part of a roller according to another exemplary embodiment of the present disclosure by enlarging portion B of FIG. 8;

FIGS. 10 and 11 are views schematically illustrating a procedure for performing the crimping process by the roller according to an exemplary embodiment of the present disclosure;

FIG. 12 is an enlarged view schematically illustrating a procedure for continuously performing the crimping process by the roller according to an exemplary embodiment of the present disclosure; and

FIGS. 13 and 14 are flowcharts of the crimping process using the crimping apparatus according to an exemplary embodiment of the present disclosure.

### DETAILED DESCRIPTION OF THE INVENTION

As used herein, the singular form may include the plural form unless the context clearly dictates otherwise.

In addition, when used to describe and define the present disclosure, terms such as “comprise,” “include,” “consist of,” and “have” should be interpreted in a non-exclusive manner. Unless explicitly stated otherwise, these terms should be construed to imply the presence of the corresponding component, and thus should not be interpreted to exclude the presence of other components but rather to include them.

It should be understood that the accompanying drawings schematically illustrate the features of the present disclosure and may be reduced or enlarged relative to actual dimensions, and may be exaggerated or partially omitted for clarity.

A secondary cell 1 described in the present disclosure may be any type of conventional battery cell capable of converting chemical energy stored in the battery into electrical energy, and capable of repeated charging and discharging.

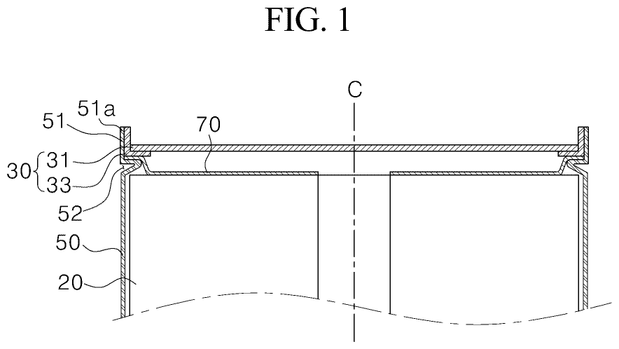

In describing various embodiments of the present disclosure, the axial direction may refer to a direction parallel to the direction in which a central axis (e.g., C of FIG. 1) extends, along which a jelly-roll-type electrode assembly 20 is wound, and the radial direction may refer to a direction extending toward or away from the central axis.

Meanwhile, since the central axis of a cylindrical battery case 50 and the central axis of the electrode assembly 20 are coaxially aligned, the axial direction in the present disclosure may be understood as a direction parallel to the direction in which a central axis of the cylindrical battery case 50 extends, and the radial direction may be understood as a direction extending from the central axis of the cylindrical battery case 50 toward the side wall.

FIG. 1 is a cross-sectional view schematically illustrating a cylindrical secondary cell 1 to which a crimping apparatus according to an exemplary embodiment of the present disclosure may be applied.

Referring to FIG. 1, the cylindrical secondary cell 1, to which the crimping apparatus according to various embodiments of the present disclosure may be applied, may include a battery case 50, the electrode assembly 20, a first current collector 70, and a cap assembly 30.

First, the battery case 50 may be formed in a cylindrical shape having an internal space. The battery case 50 may include an opening part 51 formed at an axially upper end in an open shape. The electrode assembly 20 may be inserted into the battery case 50 through the opening part 51.

The electrode assembly 20 may include a first electrode plate (not shown), a second electrode plate (not shown), and a separator (not shown). The electrode assembly 20 may be wound about a winding axis in a state where the first electrode plate and the second electrode plate are positioned so as not to contact each other by means of the separator.

A beading part 52, in which a side wall is recessed inward from an upper side of the electrode assembly 20, may be formed in the battery case 50 to fix the electrode assembly 20.

The battery case 50 may be electrically connected to the first electrode plate through the first current collector plate.

After an electrolyte is injected into the battery case 50, the cap assembly 30 may be coupled to the opening part 51 to close the battery case 50. For example, the cap assembly 30 may be seated on the beading part 52.

The cap assembly 30 may include a cap plate 31 and a sealing gasket 33.

The cap plate 31 may have a circular plate shape corresponding to the shape of the opening part 51. The cap plate 31 may be positioned so that its periphery is surrounded by the sealing gasket 33.

For example, after the sealing gasket 33 is seated on the beading part 52, the cap plate 31 may be placed on the sealing gasket 33.

The sealing gasket 33 may be arranged to extend to an upper end 51a of the opening part 51 while being interposed between the cap plate 31 and the battery case 50, and may be bent together with the opening part 51 of the battery case 50 through a crimping process.

Meanwhile, a cathode terminal connected to the second electrode plate may be provided on another portion of the battery case 50, and the cathode terminal may be disposed so as to be insulated from the battery case 50.

The structure of the cylindrical secondary cell 1 described above is an example to help understand the present disclosure, and the scope of the present disclosure is not limited to the detailed structure of the cylindrical secondary cell 1.

Meanwhile, the secondary cell 1 may be sealed through a crimping process while the cap assembly 30 is coupled to the opening part 51 of the battery case 50. The crimping process may be performed by inwardly bending a partial section of the upper portion of the side wall that forms the opening part 51.

In general, the crimping process may be performed by using a mold-pressing method or a roller-rotating and pressing method, and may be performed through two to three detailed processes depending on the thickness of the battery case 50.

In particular, as the diameter or height of the cylindrical secondary cell 1 increases, the thickness of the wall of the battery case 50 may be increased to ensure sufficient structural rigidity. When a greater pressing force is applied to the opening part 51 to bend a case with a relatively thick wall, deformation of the beading part 52 or deformation of the battery case 50 may occur.

Therefore, the crimping process is generally performed by applying a pressing force to the opening part 51 of the battery case 50 through multiple bending processes. To this end, a plurality of crimping molds or crimping rollers 300 are required.

However, as more individual molds are used, not only are additional equipment costs for the individual molds required, but additional process time is inevitably needed to move and accurately control the positions of the individual molds.

In addition, since the possibility of error in the control of individual molds increases, the possibility of generating defects in the crimping process also increases.

Therefore, in various embodiments of the present disclosure, a crimping apparatus capable of performing multiple bending processes through a single crimping roller 300 is proposed.

Hereinafter, the crimping apparatus according to various embodiments of the present disclosure will be described in detail with reference to the accompanying drawings.

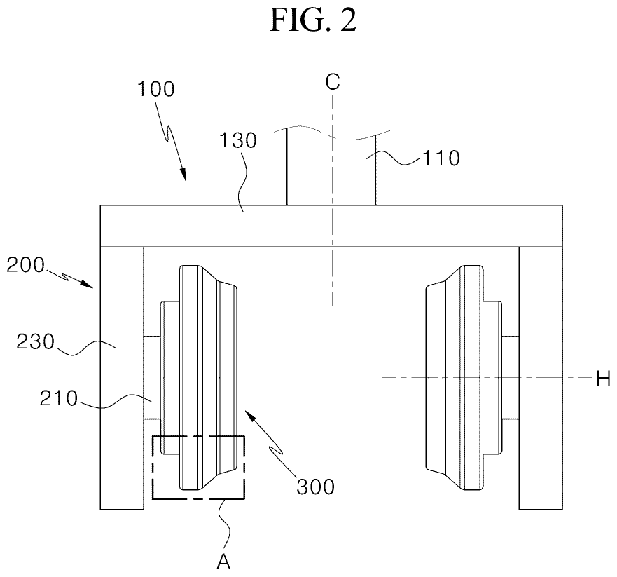

FIG. 2 is a view schematically illustrating the crimping apparatus according to an exemplary embodiment of the present disclosure.

Referring to FIG. 2, the crimping apparatus according to an exemplary embodiment of the present disclosure may include a roller support device 100, a roller driving device 200, and a roller 300.

The crimping apparatus may include the roller support device 100. The roller support device 100 may be coupled with the roller 300 to support it, thereby allowing both axial and radial movements of the roller 300.

The roller 300 may be connected to the roller support device 100. The roller 300 may also be coupled to the roller support device 100 via the roller driving device 200. The roller support device 100 may be controlled by a controller to move up and down and/or to rotate.

The roller support device 100 may be moved up and down in the axial direction. The roller support device 100 may move the roller 300 up and down. The roller support device 100 may move the axial position of the roller 300 with respect to the opening part 51 of the battery case 50. The roller support device 100 may support the roller 300 so that it is positioned at a predetermined height in the axial direction with respect to the opening part 51 of the battery case 50.

The roller support device 100 may apply a pressing force in an axially downward direction to the opening part 51 of the battery case 50 while moving the roller 300 up and down. The roller support device 100 may be controlled by the controller to adjust the force of the vertical movement, thereby adjusting the pressing force applied to the opening part 51.

The roller support device 100 may rotate about the central axis of the battery case 50. The roller support device 100 may be configured to move the roller 300 along the periphery of the opening part 51 of the battery case 50 while rotating about the central axis of the battery case 50. Here, the rotational axis about which the roller support device 100 rotates may be described as a first rotational axis (e.g., C in FIG. 2).

The roller driving device 200 may be connected to the roller support device 100. The roller 300 may be connected to the roller support device 100 via the roller driving device 200.

In an exemplary embodiment, the roller support device 100 may include a vertical support part 110 disposed coaxially with the first rotational axis and a roller support part 130 disposed below the vertical support part 110 to which the roller driving device 200 is coupled. However, it should be understood that this is merely an exemplary structure and any structure that does not deviate from the purpose of the present disclosure is possible.

The crimping apparatus may include the roller driving device 200.

The roller driving device 200 may be coupled to the roller support device 100 and may be configured to drive the roller 300 to move in the radial direction.

The roller driving device 200 may rotate about a first rotational axis by the rotation of the roller support device 100. The roller driving device 200 may be moved up and/or down in the axial direction by the roller support device 100.

The roller driving device 200 may be controlled by the controller to be movable in the radial direction while being connected to the roller support device 100. The roller 300 may be moved radially inward or outward according to the radial movement of the roller driving device 200.

The roller driving device 200 may drive the roller 300 to stop at a predetermined position in the radial direction with respect to the opening part 51 of the battery case 50. The roller driving device 200 may apply a pressing force in a radially inward direction to the opening part 51 of the battery case 50 while moving the roller 300 in the radial direction. The roller driving device 200 may be configured to have the pressing force applied to the opening part 51 adjusted by the controller by controlling the radial movement force.

In addition, the roller driving device 200 may be driven by the controller to rotate the roller 300 about a second rotational axis (e.g., H in FIG. 2). Here, the second rotational axis about which the roller 300 rotates may be formed in a direction perpendicular to the first rotational axis described above.

In an exemplary embodiment, the roller driving device 200 may include a roller driving unit 230 that is coupled to the roller support part 130 of the roller support device 100 and moves in the radial direction, and a horizontal support part 210 that extends from the roller driving unit 230 and is arranged coaxially with the second rotational axis so that the roller 300 is rotatably coupled. However, it should be understood that this is merely an exemplary structure, and any structure that does not deviate from the purpose of the present disclosure is possible.

The crimping apparatus may include the roller 300. The roller 300 may apply a pressing force to the opening part 51 of the battery case 50 to perform the crimping process.

The roller 300 may be configured to move up and down in the axial direction. The roller 300 may also be configured to move inwardly or outwardly in the radial direction.

For example, the roller 300 may be coupled to the roller support device 100 via the roller driving device 200.

The roller 300 may be configured to move up and down in the axial direction by the movement of the roller support device 100. The roller 300 may be moved downwardly in the axial direction by the roller support device 100 to apply a downward pressing force to the opening part 51 of the battery case 50.

In addition, the roller 300 may be configured to slide along the periphery of the opening part 51 of the battery case 50 by the rotation of the roller support device 100 and to apply a pressing force to the opening part 51.

The roller 300 may be provided to be movable inwardly or outwardly in the radial direction by the roller driving device 200. The roller 300 may be moved radially inward by the roller driving device 200 and may apply a pressing force in a radially inward direction to the opening part 51 of the battery case 50.

A plurality of rollers 300 may be provided. FIG. 2 illustrates that two rollers 300 are included, but it is not limited thereto, and the number of rollers may be provided to apply a balanced pressing force to the opening part 51 of the battery case 50.

For example, as shown in FIG. 2, when two rollers 300 are provided, each roller 300 may be arranged to face each other based on the central axis of the battery case 50. When the roller 300 is moved radially inward by the roller driving device 200, a gap between the facing rollers 300 may be changed to be smaller, and when the roller 300 is moved radially outward, the gap between each of the rollers 300 may be changed to be larger.

In an exemplary embodiment of the present disclosure, the roller 300 may apply a pressing force in an axially downward direction to the opening part 51 of the battery case 50 to form a crimping part.

Alternatively, in an exemplary embodiment, the roller 300 may apply a pressing force in a radially inward direction to the opening part 51 of the battery case 50 to form a crimping part.

The roller 300 may include a base part 310 connected to the roller driving device 200, and an inclined part extending from the base part 310 and contacting at least a partial section of the opening part 51 of the battery case 50 to apply a pressing force thereto.

The inclined part may include at least two or more inclined parts having different inclined structures. The roller 300 may cause the opening part 51 to be bent at different angles by means of the at least two or more inclined parts having different inclined structures.

For example, the inclined part may include an outer inclined part 330 and an inner inclined part 350, which are sequentially formed to extend radially inward from the base part 310. The outer inclined part 330 and the inner inclined part 350 may be formed so that pressing surfaces 330a and 350a that come into contact with the opening part 51 of the battery case 50 have different inclined structures.

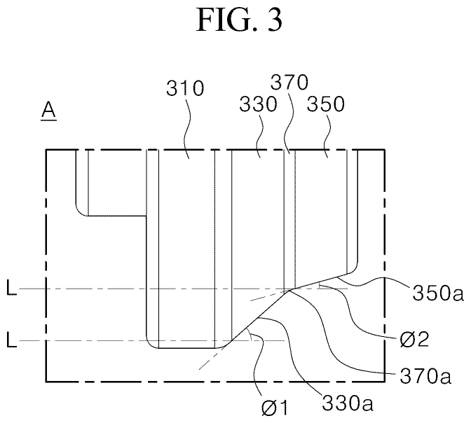

Specifically, the pressing surface 330a of the outer inclined part 330 and the pressing surface 350a of the inner inclined part 350 may be formed to have different angles with respect to an imaginary line (e.g., L of FIG. 3) that is perpendicular to the central axis C of the battery case 50 when viewed from the side.

For example, the outer inclined part 330 may be formed to form a first angle (e.g., 01 in FIG. 3) with respect to the imaginary line L when viewed from the side, and the roller 300 may apply a pressing force to the opening part 51 through the outer inclined part 330 to bend the opening part 51 to the first angle.

For example, the inner inclined part 350 may be formed to form a second angle (e.g., 02 of FIG. 3) with respect to the imaginary line L when viewed from the side, and the roller 300 may apply a pressing force to the opening part 51 through the inner inclined part 350 to bend the opening part 51 to the second angle. In this case, the first angle θ1 formed by the outer inclined part 330 with respect to the imaginary line Land the second angle θ2 formed by the inner inclined part 350 with respect to the imaginary line L may be different from each other.

Meanwhile, when viewed from the side, the length of the pressing surface 350a of the inner inclined part 350 and the length of the pressing surface 330a of the outer inclined part 330 may be formed to be equal to or longer than the length of the section to be bent in the opening part 51 of the battery case 50.

In the present disclosure, as the roller 300 moves inward or outward in the radial direction, the roller 300 may sequentially apply a pressing force to the opening part 51 of the battery case 50 through the inner inclined part 350 and the outer inclined part 330.

For example, the controller may control the position of the roller 300 so that the inclined part of the inner inclined part 350 and the outer inclined part 330 of the roller 300, which is formed to have a larger angle, presses the opening part 51 first, and the inclined part having a smaller angle presses the opening part 51 later.

In the present disclosure, the position of the roller 300 may be controlled to move so that the inner inclined part 350 and the outer inclined part 330 having different inclinations may sequentially apply a pressing force to the opening part 51, thereby gradually bending the opening part 51 of the battery case 50 and enabling multiple bending processes to be performed by a single crimping apparatus.

In particular, in the present disclosure, the pressing force applied to the bent portion of the opening part 51 of the battery case 50 may be sequentially distributed and applied by the single roller 300.

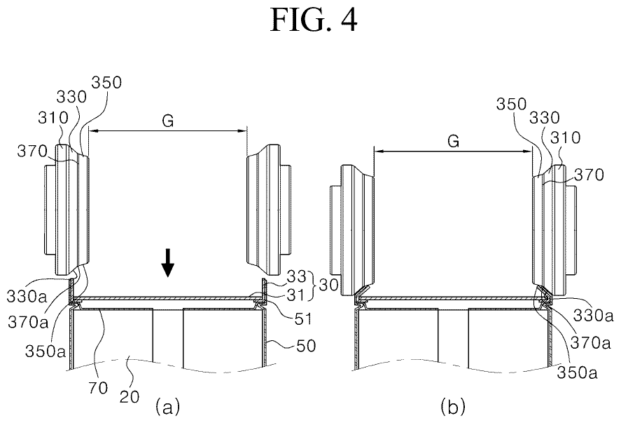

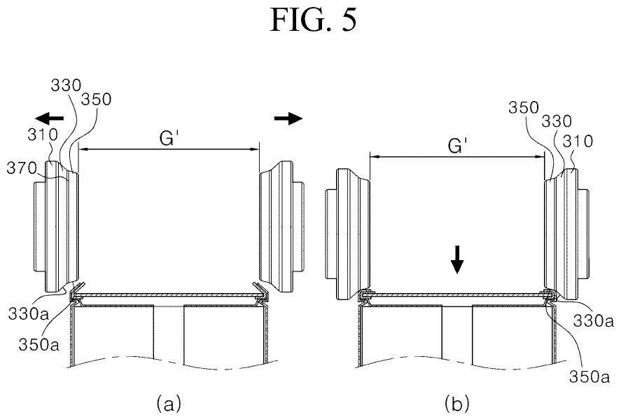

FIG. 3 is a view illustrating the inclined structure of the inclined part according to an exemplary embodiment by enlarging portion A of FIG. 2, and FIGS. 4 and 5 are views schematically illustrating the procedure for performing the crimping process by the roller 300 according to the embodiment of FIG. 3.

First, referring to FIG. 3, the inclined part of the roller 300 may include the outer inclined part 330 and the inner inclined part 350, which are sequentially formed radially inward from the base part 310.

The outer inclined part 330 and the inner inclined part 350 may be formed to have different inclined structures when viewed from the side. In an exemplary embodiment, the outer inclined part 330 may be formed to have a greater inclination than the inner inclined part 350. Specifically, as shown in FIG. 3, when viewed from the side, the first angle θ1 formed by the pressing surface 330a of the outer inclined part 330 with the imaginary line L may be formed to be greater than the second angle θ2 formed by the pressing surface 350a of the inner inclined part 350 with the imaginary line L.

For example, the first angle θ1 formed by the pressing surface 330a of the outer inclined part 330 with the imaginary line L may be formed to be greater than 0° and less than 90°, and the second angle θ2 formed by the pressing surface 350a of the inner inclined part 350 with the imaginary line L may be formed to be greater than or equal to 0° and less than the first angle θ1.

In this case, a buffer part 370 may be further formed between the outer inclined part 330 and the inner inclined part 350. The buffer part 370 may be formed by connecting the pressing surface 330a of the outer inclined part 330 and the pressing surface 350a of the inner inclined part 350 when viewed from the side, and may include a curved surface 370a having a predetermined curvature that is convex upward. The curved surface 370a may alleviate the impact before the end 51a of the opening part 51 sliding along the outer inclined part 330 having a large inclination comes into contact with the inner inclined part 350 having a relatively small inclination.

In an exemplary embodiment, the opening part 51 of the battery case 50 may be first pressed by the outer inclined part 330 of the roller 300 to be primarily bent, and then when the roller 300 is moved radially outward, the opening part 51 may be pressed by the inner inclined part 350 of the roller 300 to be secondarily bent, thereby forming the crimped part.

Next, referring to FIGS. 4 and 5, a crimping method using a crimping apparatus according to an exemplary embodiment of the present disclosure will be described in detail.

### Initial Alignment Process

As shown in FIG. 4(a), the crimping apparatus may be configured such that the roller 300 is positioned on the upper side of the opening part 51 of the battery can in an initial state while the first rotational axis is aligned with the central axis of the battery can. Specifically, the outer inclined part 330 of the roller 300 may be positioned on the upper side of the opening part 51, and more specifically, the outer end of the outer inclined part 330 of the roller 300 may be arranged such that it is aligned with the upper end of the opening part 51 along the axial direction.

For example, the initial alignment position of the roller 300 may be a preset position. Alternately, a position sensing process may be performed by a separate sensor under the control of the controller, thereby allowing precise alignment of the roller 300 and also adjusting the alignment if necessary.

For example, when two rollers 300 are arranged, each roller 300 may be spaced apart with an initial gap G.

### Primary Pressing Process

Thereafter, as shown in FIG. 4(b), the roller 300 may be moved axially downward. As the roller 300 is lowered, a downward pressing force may be applied to the opening part 51 by the outer inclined part 330, so that the opening part 51 may be bent inwardly toward the central axis of the can along the pressing surface 330a of the outer inclined part 330 from the end 51a thereof. In this case, the opening part 51 may be bent at the first angle by the outer inclined part 330, and the sealing gasket 33 may also be bent along with the opening part 51 of the battery can.

### Roller 300 Movement and Secondary Alignment Process

When the opening part 51 is bent to a preset height (e.g., the bending point in FIG. 4), the primary pressing process is completed. Thereafter, as shown in FIG. 5(a), the roller 300 may be moved radially outward away from the central axis of the battery case 50. Specifically, the roller 300 may be moved radially outward to a position where the portion in which the inner inclined part 350 of the roller 300 begins is axially aligned with the bending point of the opening part 51. In this case, the gap G′ between the facing rollers 300 may be larger than the above-described initial gap.

For example, the position where the roller 300 is moved radially may be a preset position. Alternatively, the position where the roller 300 is moved radially may be sensed by the separate sensor under the control of the controller, thereby allowing precise alignment of the roller 300 and also adjusting the alignment if necessary.

### Secondary Pressing Process

Referring to FIG. 5(b), the roller 300 may be moved axially downward again, and as a result of the downward movement of the roller 300, the inner inclined part 350 may apply a downward pressing force to the opening part 51. When the roller 300 is moved to the preset lowermost position, the opening part 51 is bent to the second angle by the inner inclined part 350, and the opening part 51 may be hermetically coupled to the cap assembly.

Here, the roller 300 is described as including the inner inclined part 350 and the outer inclined part 330, but additional inclined parts having different inclined structures may be formed subsequently as needed.

For example, an additional inclined part (not shown) may be further formed on the inner side of the inner inclined part 350. In this case, the pressing surface of the additional inclined part may be formed to be inclined downwardly as it extends inward when viewed from the side.

The additional inclined part may additionally press the end 51a of the opening part 51 by moving downward while the roller 300 is moved radially outward. The additional inclined part may further improve the airtightness of the opening part 51 and the cap assembly.

As described above, in the present disclosure, since the opening part 51 of the battery case 50 is gradually bent by the inner inclined part 350 and the outer inclined part 330 of the roller 300 having different inclined structures in the crimping process, deformation of the battery case 50 may be prevented.

In addition, in the present disclosure, as the roller 300 moves in the radial direction, the inner inclined part 350 and the outer inclined part 330 of the roller 300 having different inclined structures may sequentially bend the opening part 51, so that multiple bending processes may be performed through the single crimping apparatus.

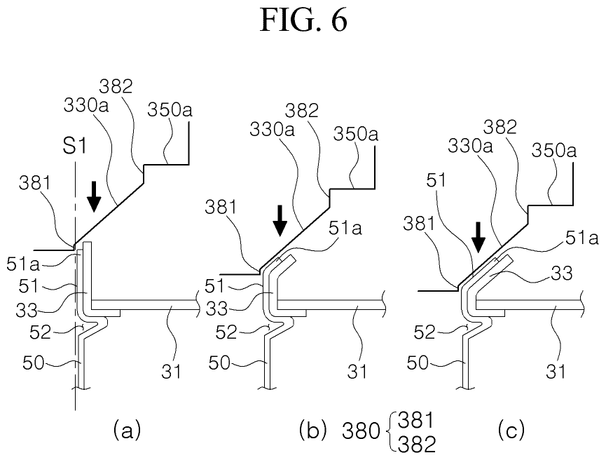

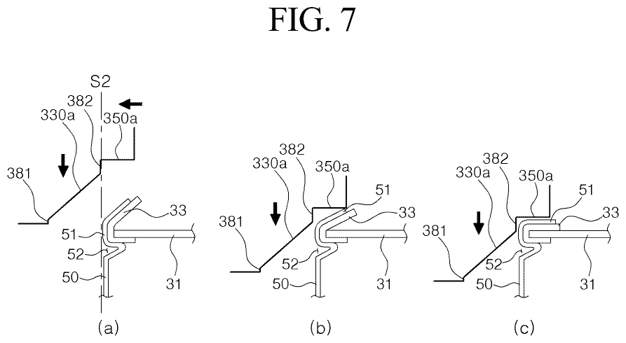

FIGS. 6 and 7 are enlarged schematic views illustrating a procedure for performing the crimping process by the roller 300 according to an exemplary embodiment of the present disclosure.

In the embodiment described in FIGS. 6 and 7, the roller 300 may further include a guide part 380 configured to guide the alignment of the opening part 51 with the roller 300 before pressing the opening part 51 through downward movement. Except for the alignment process by the guide part 380, this embodiment is the same as the embodiment described in FIG. 3. Therefore, the differences will mainly be described herein.

In the exemplary embodiment, the roller 300 may have an outer guide part 381 formed between the base part 310 and the outer inclined part 330. The outer guide part 381 may be formed to extend axially between the base part 310 and the outer inclined part 330 when viewed from the side as shown in FIG. 6.

In addition, the inner guide part 382 may be formed to extend axially between the outer inclined part 330 and the inner inclined part 350.

As shown in FIG. 6(a), the crimping apparatus may be configured such that the outer guide part 381 of the roller 300 and the opening part 51 of the battery case 50 are aligned (S1) vertically in the initial state while the first rotational axis is aligned with the central axis of the battery case 50.

For example, the controller may perform the initial alignment by moving the roller 300 to a preset position. For example, the controller may control the alignment state of the roller 300 by sensing the images of the outer guide part 381 and the opening part 51 using separate sensors, and may also adjust the radial position of the roller 300 if necessary.

When the initial alignment is completed, the roller 300 may be lowered to primarily press the opening part 51 to bend it at the first angle.

Afterwards, when the primary pressing by the outer inclined part 330 is completed, the controller may move the roller 300 radially outward to the preset alignment position S2, as shown in FIG. 7(a). Alternatively, the controller may control the alignment (S2) state of the roller 300 by sensing the images of the inner guide part 382 and the side wall of the battery case 50.

In an exemplary embodiment, the controller may more easily perform the alignment of the outer inclined part 330 by the outer guide part 381. In addition, the controller may more easily perform the alignment after the radial movement of the roller 300 by using the inner guide part 382.

Thereafter, the roller 300 may be lowered again to secondarily press the opening part 51, which has been bent at the first angle, thereby bending it to the second angle.

Meanwhile, in an exemplary embodiment, the second angle θ2 of the inner inclined part 350 may be formed as 0°, which is smaller than the first angle, and the opening part 51 may be bent perpendicular to the axial direction by being pressed by the inner inclined part 350, thereby enabling it to be more tightly coupled with the cap assembly.

In the present disclosure, the roller 300 is provided to be movable in the radial direction, so that the opening part 51 may be gradually bent by the single roller 300.

In the present disclosure, the gradual bending process of the opening part 51 may be performed by the single roller 300, thereby reducing manufacturing costs and improving process efficiency.

Further, in the present disclosure, it is possible to prevent deformation of the beading part 52 and the case even when the crimping part is formed in a thick battery case 50 by gradually bending the opening part 51 of the battery case.

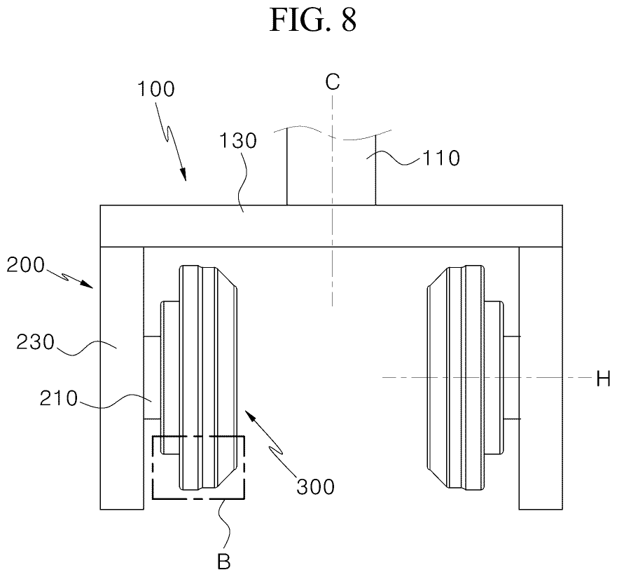

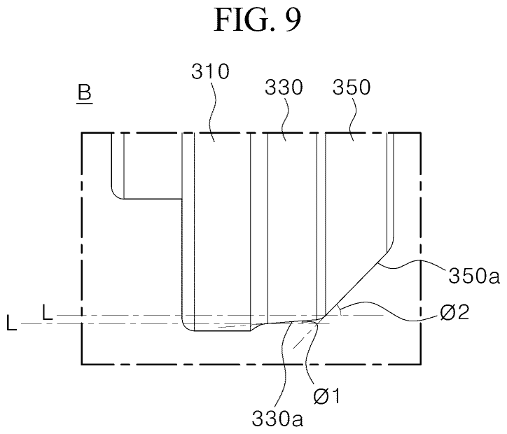

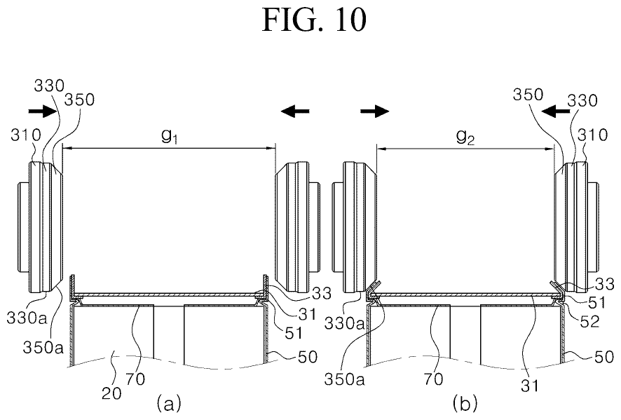

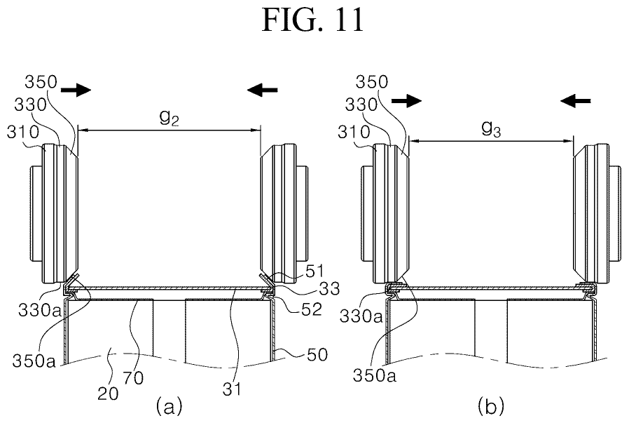

FIG. 8 is a view schematically illustrating a crimping apparatus according to another exemplary embodiment of the present disclosure, FIG. 9 is a view illustrating an inclined structure of an inclined part of a roller 300 according to another exemplary embodiment by enlarging portion B of FIG. 8, and FIGS. 10 and 11 are views illustrating a procedure by which the crimping process is performed by the roller 300 according to the embodiment of FIG. 9.

In this embodiment, except for the inclined structures of an inner inclined part 350 and an outer inclined part 330 of the roller 300, the structure of the crimping apparatus is the same as that of the previously described embodiment. Therefore, the difference in the inclined structures of the inner inclined part 350 and the outer inclined part 330 and the difference in the crimping method according to the difference will mainly be described here.

Referring to FIG. 9, in the exemplary embodiment of the present disclosure, the inclined part of the roller 300 may include the outer inclined part 330 and the inner inclined part 350, which are sequentially formed radially inward from the base part 310.

For example, the axial height from an outer end of the outer inclined part 330 to an inner end of the inner inclined part 350 may be formed to be equal to or greater than the height at which the opening part 51 of the battery case 50 is finally bent.

The outer inclined part 330 and the inner inclined part 350 may be formed to have different inclined structures when viewed from the side.

In an exemplary embodiment, the outer inclined part 330 may be formed to have a smaller inclination than the inner inclined part 350. For example, when viewed from the side, a first angle θ1 formed by a pressing surface 330a of the outer inclined part 330 with an imaginary line L may be formed to be smaller than a second angle θ2 formed by a pressing surface 350a of the inner inclined part 350 with the imaginary line L.

For example, the second angle θ2 formed by the pressing surface 350a of the inner inclined part 350 with the imaginary line L may be formed to be greater than 0° and less than 90°, and the first angle θ1 formed by the pressing surface 330a of the outer inclined part 330 with the imaginary line L may be formed to be greater than or equal to 0° and less than the second angle θ2.

Further, in an exemplary embodiment, the roller 300 may further include a stopper part 390 disposed between the base part 310 and the outer inclined part 330. The stopper part 390 may be formed to extend axially between the base part 310 and the outer inclined part 330 when viewed from the side. The stopper part 390 may limit the radially inward movement of the roller 300.

FIGS. 10 and 11 are views schematically illustrating a procedure by which the crimping process is performed by the roller 300 according to the embodiment of FIG. 9.

In this embodiment, the crimping apparatus may form the crimped part by applying a pressing force in a radially inward direction to the opening part 51.

In this embodiment, the crimping process may be performed by pressing the opening part 51 while the roller 300 continuously moves inward at a predetermined height.

### Initial Alignment Process (Height Alignment Process)

First, as shown in FIG. 10(a), in the initial alignment process, the crimping apparatus may be configured such that the inner end of the inner inclined part 350 of the roller 300 is radially aligned with the end 51a of the opening part 51 in the initial state while the first rotational axis is aligned with the central axis of the battery case 50. The roller 300 may be positioned farther radially outward than the opening part 51.

For example, the height of the outer end of the outer inclined part 330 may be the same as the height at which the opening part 51 is bent. In this case, a gap g1 between the facing rollers 300 may be the widest gap during the crimping process in this embodiment.

For example, the initial alignment process may be performed by the controller by moving the roller 300 to a preset position. Alternatively, the controller may control the alignment state of the roller 300 using a separate sensor and also adjust the radial position of the roller 300.

### Primary Pressing Process

Referring to FIG. 10(b), the roller 300 is then moved radially inward, and the inner inclined part 350 of the roller 300 may apply a pressing force in a radially inward direction to the opening part 51. The opening part 51 may be bent at the second angle by being pressed radially inward by the inner inclined part 350 of the roller 300. In this case, a gap g2 between the facing rollers 300 may be smaller than the gap g1 between the rollers 300 in the above-described initial alignment process.

### Secondary Pressing Process

Referring to FIG. 10(b) again, as the roller 300 continues to move radially inward, the outer inclined part 330 of the roller 300 may come into contact with the opening part 51 after passing the inner inclined part 350. The outer inclined part 330 of the roller 300 may continuously apply a pressing force in a radially inward direction to the opening part 51. The opening part 51 may be bent to the first angle that is smaller than the second angle by the outer inclined part 330 of the roller 300. In this case, a gap g3 between the facing rollers 300 may be smaller than the gap g2 between the rollers 300 in the pressing process through the above-described inner inclined part 350.

In this embodiment, after the height of the roller 300 is aligned in the initial alignment process, the process of continuously bending the opening part 51 may then be performed at the same height. Therefore, the controller does not require additional vertical movement control, so that easier control of the crimping apparatus in the process may be possible.

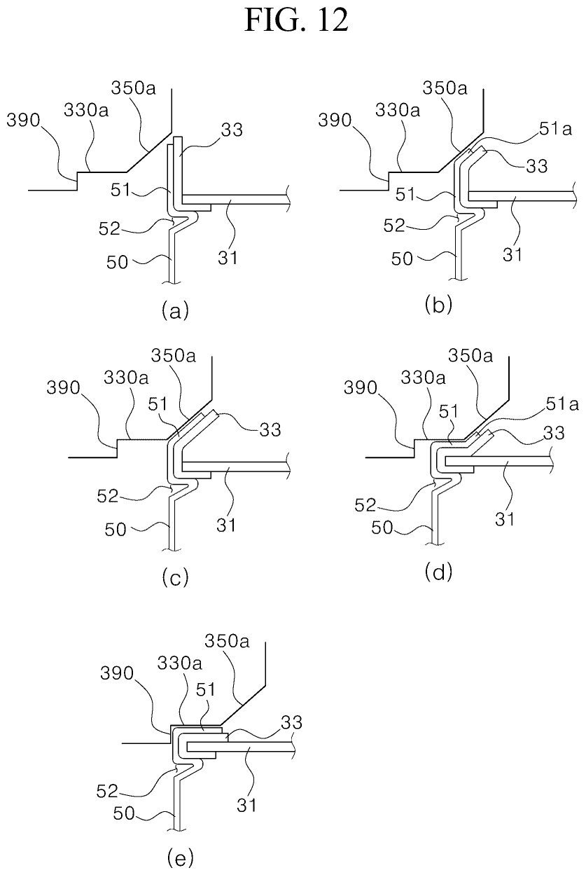

FIG. 12 is an enlarged view schematically illustrating a procedure for continuously performing the crimping process by the roller 300 according to an exemplary embodiment of the present disclosure.

Except for a stopper part 390 formed between the base part 310 and the outer inclined part 330, and the fact that first angle of the outer inclined part 330 is formed a 0°, this embodiment is the same as the embodiment of FIG. 8 described above. Therefore, the differences will mainly be described here.

Referring to FIG. 12(a), in the initial alignment process, the crimping apparatus may be configured to lower the roller 300 so that the inner end of the inner inclined part 350 comes into contact with the end 51a of the opening part 51. The controller may control the position so that the inner end of the inner inclined part 350 of the roller 300 is radially aligned with the end 51a of the opening part 51 while the first rotational axis of the crimping apparatus is aligned with the central axis of the battery case 50.

As shown in FIG. 12(b), in this state, the roller 300 may be moved radially inward by the roller driving device 200 without axial movement, and the inner inclined part 350 of the roller 300 may apply a pressing force in a radially inward direction to the end 51a of the opening part 51.

As shown in FIG. 12(c), as the roller 300 gradually moves radially inward, the end 51a of the opening part 51 of the battery case 50 may be bent toward the central axis of the battery case 50. Here, the process in which the opening part 51 is pressed by the inner inclined part 350 may be described as a primary pressing process. In the primary pressing process, the opening part 51 may be bent at the second angle according to the inclined structure of the inner inclined part 350.

In this embodiment, since the second angle of the inner inclined part 350 is formed to be greater than the first angle of the outer inclined part 330, the primary pressing process may be described as a process of preliminarily forming an inclination in the opening part 51 so that the opening part 51 may be easily bent in the secondary pressing process.

Then, the roller 300 continues to move radially inward, and as shown in FIG. 12(d), the opening part 51 may be bent to the first angle that is smaller than the second angle by being pressed by the outer inclined part 330 of the roller 300. Here, the process in which the opening part 51 is pressed by the outer inclined part 330 may be described as a secondary pressing process. In the present disclosure, since the opening part 51 is preliminarily inclined through the primary pressing process described above, the opening part 51 may be bent more easily in the secondary pressing process.

Meanwhile, in an exemplary embodiment, the first angle θ1 of the outer inclined part 330 may be formed as 0°, which is smaller than the second angle, and the opening part 51 may be bent vertically in the axial direction by being pressed by the outer inclined part 330, thereby enabling it to be more tightly coupled with the cap assembly.

In addition, in this embodiment, when the secondary pressing process by the outer inclined part 330 is completed, the stopper part 390 formed vertically between the outer inclined part 330 and the base part 310 may limit the radial movement of the roller 300. Therefore, wear of the opening part 51 due to unnecessary friction between the roller 300 and the opening part 51 may be prevented.

Further, according to this embodiment, the crimping process according to FIGS. 12(b) to 12(e) described above may be performed without additional vertical movement of the crimping apparatus in an initially aligned state as in FIG. 12(a).

In this case, the roller 300 is continuously moved radially inward during the crimping process according to FIGS. 12(b) to (e) to apply a pressing force to the opening part 51, so that the control of the vertical movement of the crimping apparatus during the process is unnecessary, and a separate alignment process is also unnecessary, so that the process efficiency may be enhanced.

In addition, in this embodiment, the pressing force in a radially inward direction is applied to the opening part 51 and a direct downward pressing force is not applied, so that deformation of the beading part 52 may be prevented.

Meanwhile, the process of applying a pressing force to the opening part 51 by the roller 300 during the crimping process described above may be performed while the roller 300 rotates along the periphery of the opening part 51 as the crimping apparatus rotates about the first rotational axis, and while the roller 300 rotates about the second rotational axis.

Hereinafter, the crimping process using the crimping apparatus according to various embodiments of the present disclosure will be described.

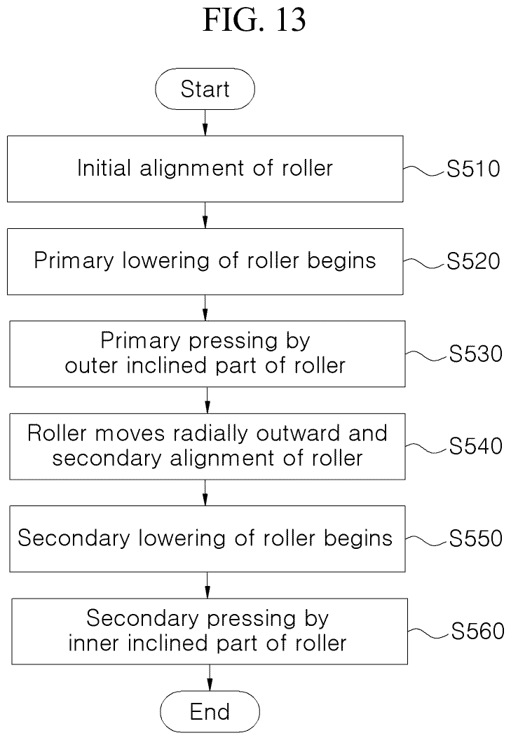

FIG. 13 is a flowchart of the crimping process using the crimping apparatus according to the embodiment of FIG. 2.

Referring to FIG. 13, when the cap assembly is seated in the opening part 51 of the battery case 50, a process of initial alignment of the crimping apparatus may be performed (S510). In this case, as described above, the crimping apparatus may be in a position where the first rotational axis is aligned with the central axis of the battery case 50, and the outer inclined part 330 of the roller 300 is aligned with the end 51a of the opening part 51.

With the crimping apparatus in the initial alignment state, the primary lowering of the roller 300 may begin (S520).

As the roller 300 is lowered, the opening part 51 may be primarily pressed inward by the pressing surface of the outer inclined part 330 having a greater inclination than the inner inclined part 350 (S530). In this case, the opening part 51 may be bent to the first angle.

When the pressing by the outer inclined part 330 is completed, the roller 300 may be moved radially outward by the roller driving device 200. The roller 300 may be moved until the inner inclined part 350 is aligned with the opening part 51 (secondary alignment) and then stopped (S540).

Thereafter, the roller 300 may be lowered secondarily (S550). During this secondary lowering, the roller 300 may be positioned farther radially outward than during the primary lowering.

As the roller 300 is lowered again, the opening part 51 may be secondarily pressed inward by the pressing surface of the inner inclined part 350 having a smaller inclination than the outer inclined part 330 (S560). In this case, the opening part 51 may be bent to the second angle and be hermetically coupled to the cap assembly.

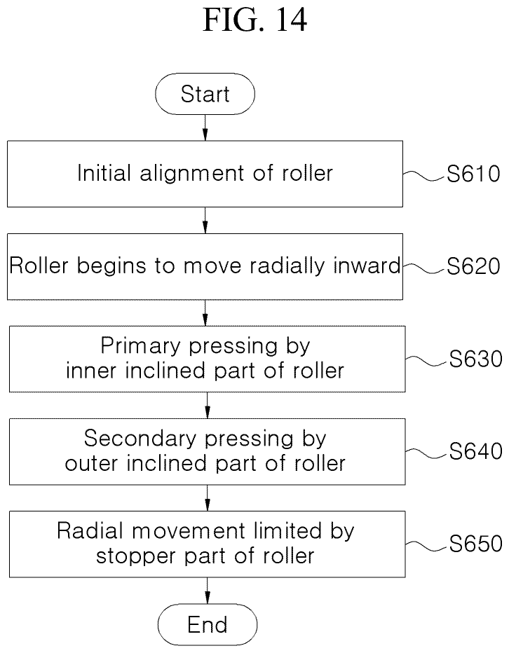

FIG. 14 is a flowchart of the crimping process using the crimping apparatus according to the embodiment of FIG. 8.

Referring to FIG. 14, when the cap assembly is seated in the opening part 51 of the battery case 50, a process of initially aligning the roller 300 to a preset height may be performed (S610). In this case, the roller 300 may be positioned farther radially outward than the opening part 51 at a height where at least a partial section of the inner inclined part 350 corresponds to the end 51a of the opening part 51.

The roller 300 may be moved radially inward from the initially aligned height (S620).

As the roller 300 moves, the roller 300 may begin to primarily press the opening part 51 by the inner inclined part 350 for the first time, and may bend the inclined part toward the inside (S630).

The roller 300 may be gradually moved radially inward from the initially aligned height and may secondarily press the opening part 51 by the outer inclined part 330 having a smaller incline than the inner inclined part 350 so that the opening part 51 may be bent downward more and more (S640).

As the outer inclined part 330 of the roller 300 gradually moves radially inward, the inner inclined part 350 may continue to press the opening part 51 so that the opening part 51 and the cap assembly may be hermetically coupled.

Meanwhile, the radially inward movement of the roller 300 may be terminated at a preset position by the controller. Alternatively, the radially inward movement of the roller 300 may be limited by the stopper part 390 when it comes into contact with the battery case 50 (S650).

The crimping apparatus according to various embodiments of the present disclosure described above does not preclude application to other embodiments, and it should be understood that all components proposed in each embodiment, within the scope and objectives of the present disclosure, may be selectively combined in one or more configurations, and may be applied to or integrated with other embodiments at least partially.

The contents described above are merely examples of applying the principles of the present disclosure, and other configurations may be further included without departing from the scope of the present disclosure.

What is claimed is:

1. A crimping apparatus comprising:
a roller support device disposed to be movable up and down in an axial direction of a battery case; and
a roller connected to the roller support device and configured to press an opening part of the battery case,
wherein the roller is disposed to be movable in a radial direction of the battery case.

2. The crimping apparatus according to claim 1, wherein the roller comprises at least two or more inclined parts having different inclined structures, and presses the opening part through the two or more inclined parts.

3. The crimping apparatus according to claim 1, wherein the roller comprises an outer inclined part and an inner inclined part extending radially inward from the outer inclined part, and
wherein the roller is configured to primarily press the opening part by one of the inner inclined part or the outer inclined part, and secondarily press the opening part by the other.

4. The crimping apparatus according to claim 3, wherein the roller is characterized in that:
a pressing surface of the outer inclined part that presses the opening part is formed to be inclined at a first angle with respect to an imaginary line perpendicular to a central axis of the battery case when viewed from the side, and
a pressing surface of the inner inclined part that presses the opening part is formed to be inclined at a second angle with respect to the imaginary line perpendicular to the central axis of the battery case when viewed from the side.

5. The crimping apparatus according to claim 4, wherein the first angle is formed to be greater than the second angle.

6. The crimping apparatus according to claim 5, wherein the roller is configured to primarily press the opening part by the outer inclined part, and secondarily press the opening part by the inner inclined part.

7. The crimping apparatus according to claim 6, wherein the roller is configured to, after primarily pressing the opening part, move radially outward, and in this state, secondarily press the opening part.

8. The crimping apparatus according to claim 6, wherein the primary pressing and the secondary pressing are performed through downward movement of the roller.

9. The crimping apparatus according to claim 5, wherein the roller comprises a buffer part formed between the outer inclined part and the inner inclined part to alleviate impact on the opening part.

10. The crimping apparatus according to claim 5, wherein the roller comprises a guide part configured to guide alignment of at least one of the inner inclined part or the outer inclined part with the opening part.

11. The crimping apparatus according to claim 4, wherein the first angle is formed to be smaller than the second angle.

12. The crimping apparatus according to claim 11, wherein the roller is configured to primarily press the opening part by the inner inclined part and secondarily press the opening part by the outer inclined part.

13. The crimping apparatus according to claim 12, wherein the roller is configured to secondarily press the opening part while moving radially inward after primarily pressing the opening part.

14. The crimping apparatus according to claim 12, wherein the roller performs the primary pressing and the secondary pressing at the same height with respect to the opening part.

15. The crimping apparatus according to claim 11, wherein the roller comprises a stopper part formed on an outer end of the outer inclined part to limit the radial movement of the roller.

16. The crimping apparatus according to claim 1, wherein the roller support device is disposed to be rotatable about a central axis of the battery case, and
the roller slides along a periphery of the opening part according to the rotation of the roller support device to press the opening part.

17. The crimping apparatus according to claim 1, wherein the roller is disposed to be rotatable about a rotational axis that is perpendicular to the axial direction.

18. The crimping apparatus according to claim 1, further comprising a roller driving device that is connected to the roller and coupled to the roller support device to allow the roller to move in a radial direction.

19. A method for crimping a cylindrical secondary cell, comprising:
initially aligning a crimping apparatus, which comprises a roller, with respect to an opening part of a battery case;
primarily lowering the roller to primarily press the opening part by an outer inclined part of the roller;
moving the roller radially outward; and
secondarily lowering the roller to secondarily press the opening part by an inner inclined part of the roller.

20. A method for crimping a cylindrical secondary cell, comprising:
initially aligning a crimping apparatus, which comprises a roller, with respect to an opening part of a battery case;
moving the roller radially inward to primarily press the opening part by an inner inclined part of the roller;
continuously moving the roller radially inward to secondarily press the opening part by an outer inclined part of the roller.
